(19) United States
(12) Patent Application Publication
(10) Pub. No.: US 2019/0212583 A1
(43) Pub. Date: Jul. 11, 2019

(54) FILTER AREA STRUCTURE OF LENS

(71) Applicant: BRIGHTEN OPTIX CORP., Taipei (TW)

(72) Inventor: I-Tsung WU, Taipei (TW)

(21) Appl. No.: 15/864,137

(22) Filed: Jan. 8, 2018

(51) Int. Cl. G02C 7/10

(52) U.S. Cl. CPC G02C 7/105; G02C 7/04

(57) ABSTRACT

The present disclosure illustrates a filter area structure of lens, and the lens includes a central optical area and a peripheral optical area surrounding the central optical area, and the central optical area is formed at a central part of the lens, and light passes the central optical area to clearly image on a central imaging area of a retina of a user's eyeball, and the filter area structure comprises a filter area formed on the peripheral optical area and configured to filter out a preset percentage of visible light, and the light passing the filter area images on different area of macula of retina of the user's eye, thereby effectively delaying or preventing undesired growth of the eye axis, and further achieving the objective of correcting or controlling myopia.

### BACKGROUND OF THE INVENTION

### 1. Field of the Invention

The present disclosure relates to a filter area structure of lens, more particularly to the lens which comprises a filter area formed on a peripheral optical area thereof, and the filter area can filter out visible light by a preset percentage; as a result, the visible light strikes different areas around macula of retina, so as to effectively delay or stop extension of eye axis, thereby achieving the purpose of correcting or controlling myopia.

### 2. Description of the Related Art

Generally, a user must wear frame glass or contact lens for vision correction. The frame glass or the contact lens has a central optical area, and a peripheral optical area around a peripheral optical center. Through the central optical area and the peripheral optical area, an external object can be clearly and distortionlessly projected and imaged on retina of the user's eyeball.

Generally, lens of the glasses is usually transparent to transmit visible light into the eye, and lens of sunglasses is formed with the same color on entire area thereof to filter light and reduce strength of light.

Generally, color contact lens is also formed with the same color on entire area thereof, and it is easier for the user to find and wear such color contact lens. Other color contact lens, such as circle contact lens, has a non-transparent color part to block external light from passing through the non-transparent color part into the user's eye. For this reason, existing sunglasses lens or color contact lens is unable to effectively delay or prevent myopia from being deeper.

### SUMMARY OF THE INVENTION

In order to solve above-mentioned problem, the present disclosure provides a filter area structure of lens, and the lens includes a central optical area and a peripheral optical area surrounding the central optical area, and the central optical area is formed at a central part of the lens, and light passes the central optical area to clearly image on a central imaging area of a retina of a user's eyeball, and the filter area structure comprises a filter area formed on the peripheral optical area and configured to filter out a preset percentage of visible light, and the light passing the filter area images on different area of macula of retina of the user's eye, so that the cone cells at different positions can be stimulated by different light having different wavelengths in different strength, thereby effectively delaying or preventing undesired growth of the eye axis, and further achieving the objective of correcting myopia.

Other objective of the present disclosure is to provide a filter area structure of lens, and various cone cells can be stimulated by the light passing the filter area, and the stimulated cone cells can prevent eye axis of the eye ball from extending backwardly, thereby achieving effect of preventing myopia from being deeper.

### BRIEF DESCRIPTION OF THE DRAWINGS

The structure, operating principle and effects of the present disclosure will be described in detail by way of various embodiments which are illustrated in the accompanying drawings.

FIG. 1 is a schematic plan view of filter area structure of lens, in accordance with of an embodiment of the present disclosure.

FIG. 2 is a schematic view of an optical path of the present disclosure.

FIG. 3 is a schematic plan view of a filter area structure of lens, in accordance with of another embodiment of the present disclosure.

### DETAILED DESCRIPTION OF THE PREFERRED EMBODIMENTS

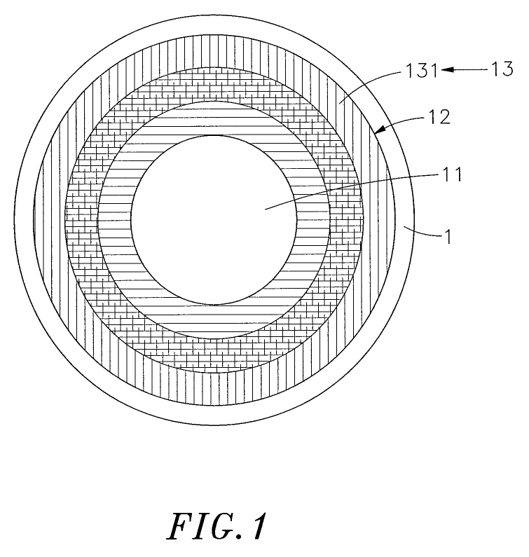

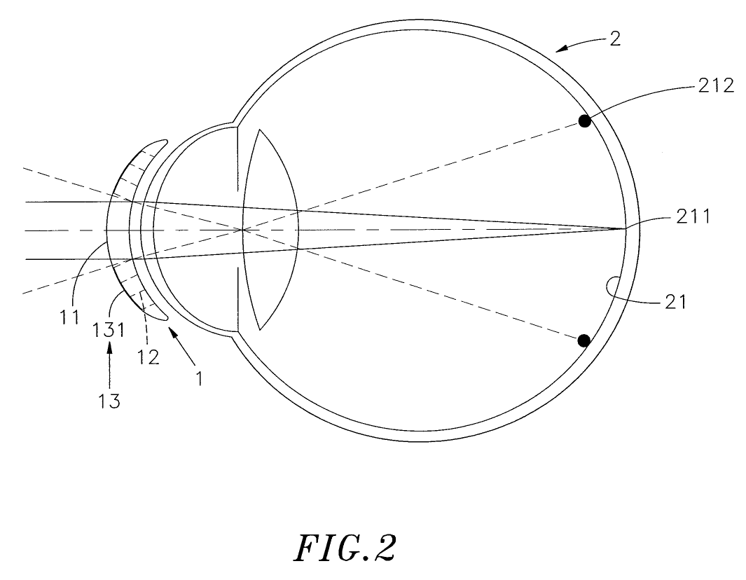

Please refer to FIGS. 1 through 3. A lens 1 includes a central optical area 11 formed at a central part thereof, and light can pass through the central optical area 11 to clearly image on a central imaging area 211, which is also called as the macula, of a retina 21 of a user's eyeball 2. The lens 1 also includes a peripheral optical area 12 surrounding a periphery of the central optical area 11, and a filter area 13 formed on the peripheral optical area 12. The filter area 13 is formed with a plurality of colors in a preset ratio, and configured to filter out a preset percentage of visible light passing therethrough, so that the filtered visible light can strike a peripheral imaging area 212 around the central imaging area 211 of the retina 21. The peripheral imaging area 212 surrounds the periphery of the macula. The filter area 13 includes at least one coloring ring 131.

In a preferred embodiment, the lens 1 is a lens of contact lens; however, in actual application, the lens 1 can also be lens of a frame glass.

Preferably, the filter area 13 can be directly formed on an outer surface of the lens 1; but in actual application, the filter area 13 can also formed in a middlesection between an inner surface and the outer surface of the lens; in an embodiment, a filter having the filter area 13 can be attached on an outer surface of the lens 1 and the filter area 13 is formed on the filter, the filter having the filter area 13 can filter out the preset percentage of visible light. In a preferred embodiment, the filter having the filter area 13 is attached on the outer surface of the lens 1 and the filter has a curvature and a size corresponding to the outer surface of the lens 1. In other embodiment, the filter having the filter area 13 can be attached to cover only peripheral optical area 12 of the outer surface of the lens 1. There are many manners of forming the filter area 13 on the lens 1, and these manners are different in various applications, so the persons skilled in the art can modify above-mentioned embodiment upon actual demand but the modifications are covered by the scope of the disclosure set forth in the claims.

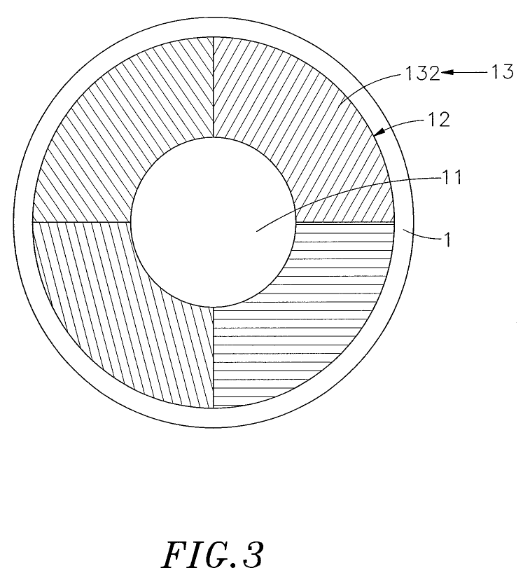

Furthermore, the filter area 13 can have a plurality of coloring rings 131 which surround the central optical area 11 in a concentric arrangement; in an embodiment, the filter area 13 can also be formed by a plurality of coloring areas 132 located a top part, a bottom part, a left part, or a right part thereof or a combination thereof, as shown in FIG. 3. However, the filter area 13 can be formed in various shapes and patterns on the peripheral optical area 12, so the persons skilled in the art can modify above-mentioned embodiment upon actual demand but the modifications are covered by the scope of the disclosure set forth in the claims.

The filter area 13 of the lens 1 can filter out the preset percentage of the visible light, and the preset percentage is in range of 1% to 100%, so that the light passing the lens can image on the peripheral imaging area 212 on the periphery of the retina 21 of eyeball 2. Blue color is a contrasting color of red color, so the preset ratio of the color of the filter area 13 is formed by blue color and at least one other color, for example, by more than 50% of blue color and less than 50% of at least one other color. In an embodiment, the color of the filter area 13 can be formed by 85% of blue color and 15% of green color; or, by 80% of blue color, 10% of green color and 10% of red color. The filter area 13 can filter out 30% of the visible light having wavelength in range of 570 nm to 750 nm, so that the light having longer wavelength, for example, red light having wavelength in a range of 620 nm to 750 nm, strikes the retina 21 of the eyeball 2 with less strength. As a result, the image formed on the central imaging area 211 of the retina 21 is complete, but the image formed on the peripheral imaging area 212 varies dependent on different designs of the filter area 13.

In an embodiment, the peripheral optical area 12 of the lens 1 can be printed by pad print manner using ink or dyestuff, to form the filter area 13; in other embodiment, the filter area 13 can be formed by flat-bed print manner, special UV ink screen print manner, dying process manner or coating process manner. There are various manners of forming the filter area 13 on the peripheral optical area 12, and above-mentioned embodiments are merely for exemplary illustration, but the present disclosure is not limited thereto.

Cells of the retina 21 of eyeball 2 having different spectral sensitivity for colors, are called cone cells, and according to peak wavelength of the spectral sensitivity of the cone cell, the cone cells can be classified into short cone cells, middle cone cells, and long cone cells. The peak wavelength of the spectral sensitivity of the short cone cell is in range of 420 nm to 440 nm, the peak wavelength of the light spectral sensitivity of the middle cone cell is in range of 531 nm to 555 nm, and the peak wavelength of the light spectral sensitivity of the long cone cell is in range of 564 nm to 588 nm. The light passing the filter area 13 of the lens 1 images on the peripheral imaging area 212 of the retina 21 and when the filter area 13 can pass only light having wavelength in range of 420 nm to 440 nm, 531 nm to 555 nm, or 564 nm to 588 nm, the cone cells at different areas can be stimulated by different lights having different wavelengths, and the stimulated cone cells can generate endocrines which are useful to prevent eye axis of the eyeball 2 from extending backwardly, thereby achieving effect of preventing myopia from being deeper.

The technical solution of the present disclosure has following advantages.

First, the lens 1 includes the central optical area 11 formed at the central part thereof and light can pass the central optical area 11 to clearly image on the central imaging area 211 of the retina 21 of the user's eyeball 2, and the lens 1 includes the peripheral optical area 12 surrounding the central optical area 11, The filter area 13 formed, by printing machine, on the peripheral optical area 12 and configured to filter out the preset percentage of visible light, So that light can image on different peripheral imaging areas 212 at the periphery of the central imaging area 211 (that is, macula) of the retina 21; in other words, light can image on different areas at the periphery of macula of retina, so that the cone cells at different positions can be stimulated by light having different wavelengths in different strength, thereby effectively delay or prevent the eye axis from being longer and achieving the effect of correcting or controlling myopia.

Second, the light passing the filter area 13 can stimulate various cone cells on the retina 21 at the same time, and the stimulated cone cell can secrete endocrine which is useful to suppress backward extension of the eye axis, thereby achieving of preventing myopia from being deeper.

The preferred embodiments described in the present disclosure are merely for exemplary illustration, but the present disclosure is not limited thereto. The key concept of the present disclosure is that the lens 1 includes the filter area 13 formed on the peripheral optical area 12 surrounding the central optical area 11, and configured to filter out the preset percentage of visible light, so as to stimulate the cone cells at different positions by different light having different wavelengths in different strength, thereby effectively delaying or preventing undesired growth of the eye axis, and further achieving the objective of delaying or preventing vision deviation from being worse.

The present disclosure disclosed herein has been described by means of specific embodiments. However, numerous modifications, variations and enhancements can be made thereto by those skilled in the art without departing from the spirit and scope of the disclosure set forth in the claims.

What is claimed is:

1. A filter area structure of lens, a lens comprising a central optical area and a peripheral optical area surrounding said central optical area, wherein said central optical area is formed at a central part of said lens, and light passes said central optical area to clearly image on a central imaging area of a retina of a user's eye ball, and the filter area structure comprises a filter area formed on said peripheral optical area and configured to filter out a preset percentage of visible light, and the light passing said filter area images on a peripheral imaging area of said retina of said eyeball.

2. The filter area structure according to claim 1, wherein said lens is a contact lens or a lens of a frame glass.

3. The filter area structure according to claim 1, wherein said filter area of said lens is formed with a plurality of colors in a preset ratio.

4. The filter area structure according to claim 3, wherein the preset ratio of the color of said filter area comprises more than 50% of blue color and less than 50% of at least one other color.

5. The filter area structure according to claim 3, wherein said filter area of said lens comprises at least one coloring ring.

6. The filter area structure according to claim 1, wherein said filter area of said lens is formed on an outer surface of said lens, or in a middlesection between an inner surface and the outer surface of said lens.

7. The filter area structure according to claim 1, wherein said lens comprises a filter attached on an outer surface thereof and said filter area is formed on the filter.

8. The filter area structure according to claim 1, said filter area 13 of said lens 1 can filter out the preset percentage of the visible light, and the preset percentage is in a range of 1% to 100%.

9. The filter area structure according to claim 1, wherein the light passing said filter area has a preset wavelength stimulating cone cell, and the preset wavelength is in range of 420 nm to 440 nm, 531 nm to 555 nm, or 564 nm to 588 nm.

10. The filter area structure according to claim 1, wherein said filter area on said peripheral optical area of said lens is formed by pad print manner, flat-bed print manner, special UV ink screen print manner, dying process manner or coating process manner.
